(19) United States
(12) Patent Application Publication
(10) Pub. No.: US 2009/0195055 A1
(43) Pub. Date: Aug. 6, 2009

(54) Wheel Rim

(75) Inventor: Chao-Ying CHEN, Shan-Shang Hsiang (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Alex Global Technology, Inc., Shan-Shang Hsiang (TW)

(21) Appl. No.: 12/419,728

(22) Filed: Apr. 7, 2009

Related U.S. Application Data
(63) Continuation-in-part of application No. 11/801,154, filed on May 8, 2007.

(51) Int. Cl. B60B 21/08

(52) U.S. Cl. 301/95.104

(57) ABSTRACT

A wheel rim includes an annular rim body that has an annular base wall, a pair of annular side walls, and a stop unit. The annular side walls extend respectively from lateral edges of the annular base wall. Each annular side wall includes a hollow segment and a connecting segment that interconnects the hollow segment and the annular base wall. Each hollow segment has an inner wall portion, an outer wall portion, and a tire bead retaining part projecting from the inner wall portion toward the other one of the annular side walls. Each inner wall portion is adapted for contacting a respective one of tire beads of a tire and cooperates with the stop unit and the respective tire bead retaining part to retain the respective tire bead.

### CROSS-REFERENCE TO RELATED APPLICATION

This application is a continuation-in-part (CIP) of U.S. patent application Ser. No. 11/801,154, filed on May 8, 2007, which is incorporated herein by reference in its entirety.

### BACKGROUND OF THE INVENTION

1. Field of the Invention

The invention relates to a wheel rim, more particularly to a wheel rim having annular side walls with hollow segments.

2. Description of the Related Art

As shown in FIG. 1, a conventional wheel rim 2 for retaining a plurality of spokes 1 (only one is shown) includes a pair of annular side walls 23, an annular base wall 21 that interconnects the annular side walls 23 and that is formed with a plurality of positioning holes 211 (only one is shown) spaced apart from each other, and an annular connecting wall 22 that interconnects the annular side walls 23, that surrounds the annular base wall 21, and that cooperates with the annular side walls 23 to define an annular tire retaining groove 220. Each of the annular side walls 23 includes a linking portion 231 connected to the annular base wall 21, and an end portion 232 extending from the linking portion 231 in a direction away from the annular base wall 21. The end portions 232 of the annular side walls 23 cooperate with the annular connecting wall 22 to define the tire retaining groove 220. However, when a lateral stress (F) is applied to the end portion 232 of a respective one of the annular side walls 23, the lateral stress (F) will mainly be borne by a part of the conventional wheel rim 2 where the annular side wall 23 is connected to the annular connecting wall 22, and is likely to result in cracks along an imaginary plane (K). While the drawback can be eliminated by increasing the thickness of the annular side walls 23, the weight of the conventional wheel rim 2 will be increased. In addition, by adding a pair of oblique walls (not shown), each of which extends obliquely from the annular connecting wall 22 to connect to a respective one of the annular side walls 23, the strength of the conventional wheel rim 2 is not effectively improved, and the weight thereof is undesirably increased as well.

FIG. 2 of U.S. Pat. No. 6,089,672 discloses another conventional wheel rim including left and right tire retaining walls, a spoke mounting wall that interconnects inner edges of the tire retaining walls and that is formed with a set of spoke fastening holes, and an outer connecting wall that surrounds the spoke mounting wall and that interconnects the tire retaining walls. This conventional wheel rim further includes pair of support ribs interconnecting the spoke mounting wall and the outer connecting wall such that a central compartment and two lateral compartments are formed between the outer connecting wall and the spoke mounting wall. Liquid electrolyte can enter into the compartments so that the inner surface of each of the lateral compartments is formed with an anodized coating to prevent corrosion thereof. When a tire is coupled to this conventional wheel rim, tire beads of the tire are coupled respectively to the left and right tire retaining walls, and an internal chamber is defined cooperatively by the tire, the left and right tire retaining walls, and the outer connecting wall, while passage holes that are formed in the outer connecting wall are in spatial communication with the internal chamber. However, in use, when the wheel rim is rotating, since the air inside the central and lateral compartments can not be induced to flow outwardly of this conventional wheel rim to result in air circulation, heat generated by a wheel braking action may result in degradation of the inserted tire.

U.S. Pat. No. 7,374,250 B2 discloses yet another conventional wheel rim including an annular base wall, and a pair of annular side walls that extend radially, outwardly, and respectively from lateral edges of the annular side wall. Each of the annular side walls has a hollow segment formed at an end portion thereof opposite to the annular base wall. This conventional wheel rim further includes an annular connecting wall interconnecting the hollow segments of the annular side walls, and a pair of tire coupling flanges extending radially, outwardly, and respectively from the hollow segments of the annular side walls for retaining respectively tire beads of a tire. However, in use, a lateral stress may result in cracks of the tire coupling flanges in the same manner as the conventional wheel rim illustrated in FIG. 1. In addition, since heat generated by a wheel braking action cannot be dissipated effectively, the tire beads that contact the tire coupling flanges of this conventional wheel rim are likely to be degraded by the heat after long-term use.

### SUMMARY OF THE INVENTION

Therefore, the object of the present invention is to provide a wheel rim that has a strong and light construction, and that can effectively dissipate heat generated during a wheel braking action.

Accordingly, a wheel rim of the present invention is adapted for retaining a tire thereon. The tire has a pair of annular tire beads. The wheel rim comprises an annular rim body having a horizontally disposed rim axis. The rim body includes an annular base wall, a pair of opposite annular side walls, and a stop unit. The annular base wall has two opposite lateral edges. The annular side walls extend radially, outwardly and respectively from the lateral edges of the annular base wall. Each of the annular side walls includes a hollow segment that is radially spaced apart from the annular base wall and that defines an annular hole, and a connecting segment that interconnects the hollow segment and the annular base wall. Each hollow segment has: an inner wall portion disposed at a radially inner side of the annular hole, facing the other one of the annular side walls, and having a distal edge that is distal from the annular base wall; an outer wall portion disposed at a radially outer side of the annular hole opposite to the radially inner side of the annular hole, and including a radially extending part that has a radial outer edge distal from the annular base wall, and a connecting end part that extends from the radial outer edge of the radially extending part to connect to the inner wall portion; and a tire bead retaining part projecting from the distal edge of the inner wall portion toward the other one of the annular side walls. The stop unit cooperates with the inner wall portions of the hollow segments and the tire bead retaining parts of the hollow segments to define an annular tire retaining groove. The inner wall portion of the hollow segment of each of the annular side walls includes opposite first and second surfaces facing respectively the annular tire retaining groove and the annular hole. The first surface is adapted for contacting a respective one of the tire beads of the tire and cooperates with the stop unit and the tire bead retaining part of the hollow segment to retain the respective one of the tire beads of the tire in the tire retaining groove.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary sectional view of a conventional wheel rim;

FIG. 2 is a fragmentary perspective view of a first preferred embodiment of a wheel rim according to the invention;

FIG. 3 is a fragmentary sectional view of the first preferred embodiment;

FIG. 4 is a partly cutaway perspective view of the first preferred embodiment;

FIG. 5 is a fragmentary perspective view of a second preferred embodiment of a wheel rim according to the invention;

FIG. 6 is a fragmentary sectional view of the second preferred embodiment;

FIG. 7 is a fragmentary sectional view of a third preferred embodiment of a wheel rim according to the invention; and

FIG. 8 is a fragmentary sectional view of a fourth preferred embodiment of a wheel rim according to the invention.

### DETAILED DESCRIPTION OF THE PREFERRED EMBODIMENTS

Before the present invention is described in greater detail, it should be noted that like elements are denoted by the same reference numerals throughout the disclosure.

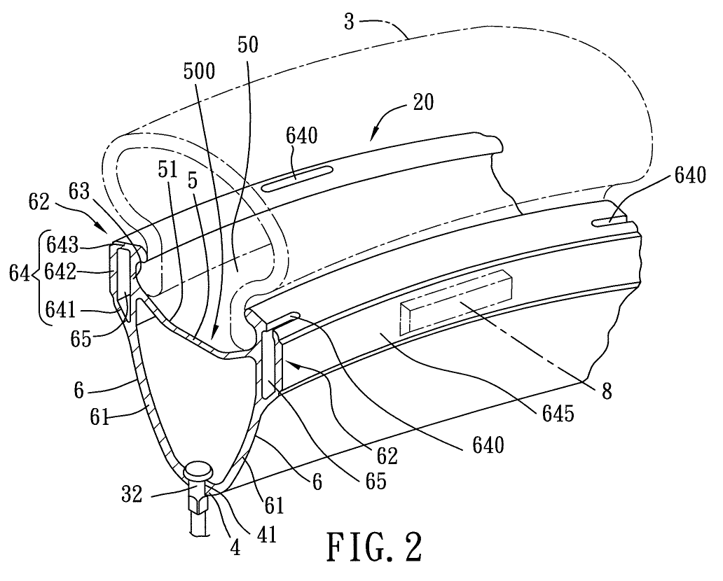

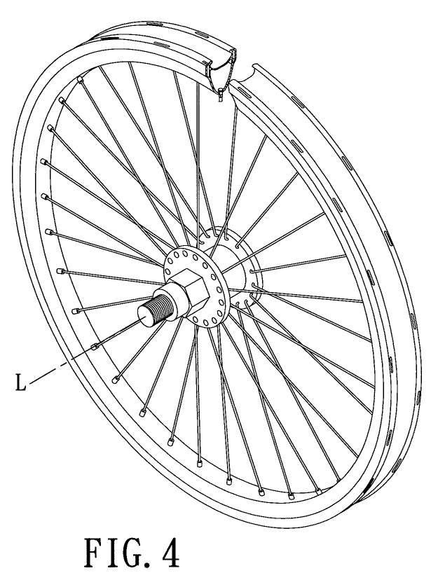

As shown in FIGS. 2 to 4, the first preferred embodiment of a wheel rim according to the present invention for retaining a tire 3 and a plurality of spoke fixing components 32 is disposed between a pair of brake pads 8, and comprises an annular rim body 20 having a horizontally disposed rim axis (L). The tire 3 has a pair of annular tire beads 31. The rim body 20 includes an annular base wall 4, a stop unit 500, and a pair of opposite annular side walls 6.

The annular base wall 4 is formed with a plurality of spoke fastening holes 41 (only one is shown) spaced apart from each other, and has two opposite lateral edges 42.

The annular side walls 6 extend radially, outwardly and respectively from the lateral edges 42 of the annular base wall 4. Each of the annular side walls 6 includes a hollow segment 62 that defines an annular hole 65. The hollow segment 62 has an inner wall portion 63 disposed at a radially inner side of the annular hole 65 and facing the other one of the annular side walls 6, and an outer wall portion 64 connected to the inner wall portion 63 and disposed at a radially outer side of the annular hole 65 opposite to the radially inner side of the annular hole 65. Each of the annular side walls 6 further includes an interior wall surface 66 that faces and defines the annular hole 65 in the hollow segment 62 thereof, and that has an elongated radial cross-section relative to the rim axis (L).

In this embodiment, the stop unit 500 includes an annular connecting wall 5 that interconnects the inner wall portions 63 of the hollow segments 62 of the annular side walls 6, that surrounds the annular base wall 4, and that cooperates with the inner wall portions 62 of the hollow segments 62 of the annular side walls 6 to define an annular tire retaining groove 50.

The inner wall portion 63 of the hollow segment 62 of each of the annular side walls 6 includes a first surface 631 facing the annular tire retaining groove 50, and a second surface 632 opposite to the first surface 631 and facing the annular hole 65. Each of the annular side walls 6 further includes a connecting segment 61 interconnecting the hollow segment 62 thereof and the annular base wall 4. In this embodiment, the inner wall portion 63 of each of the hollow segments 62 of the annular side walls 6 extends radially and outwardly from the connecting segment 61 of a respective one of the annular side walls 6, and has a distal edge 630 distal from the annular base wall 4. The outer wall portion 64 of each of the hollow segments 62 of the annular side walls 6 includes an oblique part 641 that extends obliquely and outwardly from the connecting segment 61 of the corresponding one of the annular side walls 6, a radially extending part 642 that extends from the oblique part 641 in radial outward directions relative to the rim axis (L) and that has a radial outer edge 6421 distal from the annular base wall 4, and a connecting end part 643 that extends from the radial outer edge 6421 of the radially extending part 642 to connect to the inner wall portion 63. The hollow segment 62 of each of the annular side walls 6 further has a tire bead retaining part 647 that projects from the distal edge 630 of the inner wall portion 63 of the respective one of the annular side walls 6 toward the other one of the annular side walls 6. The first surface 631 of the inner wall portion 63 of the hollow segment 62 of each of the annular side walls 6 is adapted for contacting a respective one of the tire beads 31 of the tire 3 and cooperates with the annular connecting wall 5 and the tire bead retaining part 647 of the hollow segment 62 of the respective annular side wall 6 to retain the respective one of the tire beads 31 of the tire 3 in the tire retaining groove 50, such that the hollow segments 62 are disposed respectively at radially outer sides of the tire beads 31 of the tire 3 when the tire 3 is coupled to the rim body 20.

In this embodiment, the connecting end part 643 of the outer wall portion 64 of each of the hollow segments 62 is formed with a plurality of elongated vent holes 640 spaced apart from each other and in spatial communication with the annular hole 65. Preferably, the vent holes 640 in the connecting end parts 643 of the two hollow segments 62 are staggered relative to each other. The radially extending part 642 of the outer wall portion 64 of each of the hollow segments 62 further includes a third surface 644 facing the annular hole 65, and a brake pad contacting surface 645 opposite to the third surface 644 and disposed outside the annular hole 65. The second surface 632 of the inner wall portion 63 of the hollow segment 62 of a respective one of the annular side walls 6 and the third surface 644 of the outer wall portion 64 of the same annular side wall 6 form the corresponding interior wall surface 66.

The interior wall surface 66 of each of the annular side walls 6 has a radial outer end 661 distal from the annular base wall 4 and a radial inner end 662 opposite to the radial outer end 661. The radial outer ends 661 of the interior wall surfaces 66 of the annular side walls 6 are disposed on a first imaginary cylindrical plane (H1). The radial inner ends 662 of the interior wall surfaces 66 of the annular side walls 6 are disposed on a second imaginary cylindrical plane (H2). The annular connecting wall 5 has a radial outer surface 51 that faces the annular tire retaining groove 50, and that has a pair of connecting edges 52 connected respectively to the annular side walls 6 between the first and second imaginary cylindrical planes (H1), (H2).

The interior wall surface 66 of the hollow segment 62 of each of the annular side walls 6 can distribute lateral stresses, such that the lateral stresses will not be directly applied to the inner wall portion 63 and concentrated at the connecting edge 52, thereby avoiding the occurrence of cracks.

The hollow segments 62 of the annular side walls 6 can also minimize degradation of the inserted tire 3 and other components of the rim body 20 due to heat that is generated from the friction between the brake pads 8 and the brake pad contacting surface 645 of the outer wall portion 64 of each of the annular side walls 6 during a wheel braking action. In particular, since the vent holes 640 in the outer wall portion 64 of the hollow segment 62 of each of the annular side walls 6 are in spatial communication with the annular holes 65 in the hollow segments 62, when the wheel rim is rotating, the air inside the hollow segments 62 will be induced to flow out quickly, thereby resulting in air circulation to dissipate heat. In this embodiment, the vent holes 640 are formed in the connecting end part 643 of the outer wall portion 64 of each of the annular side walls 6 for strengthening the air circulation.

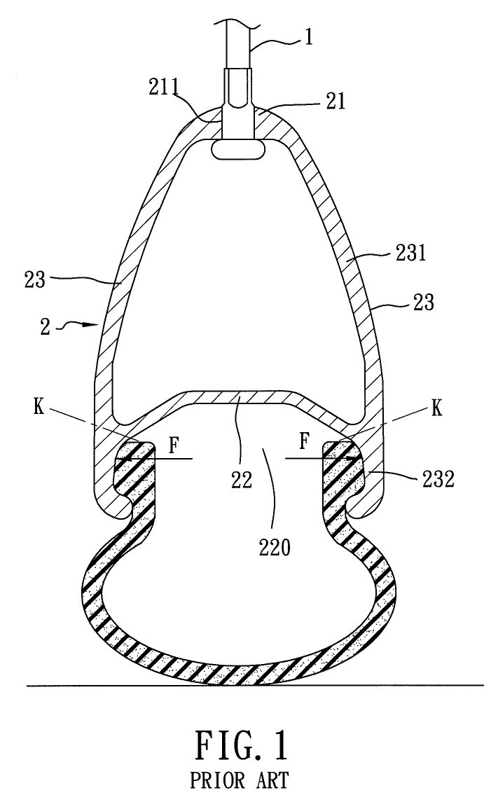

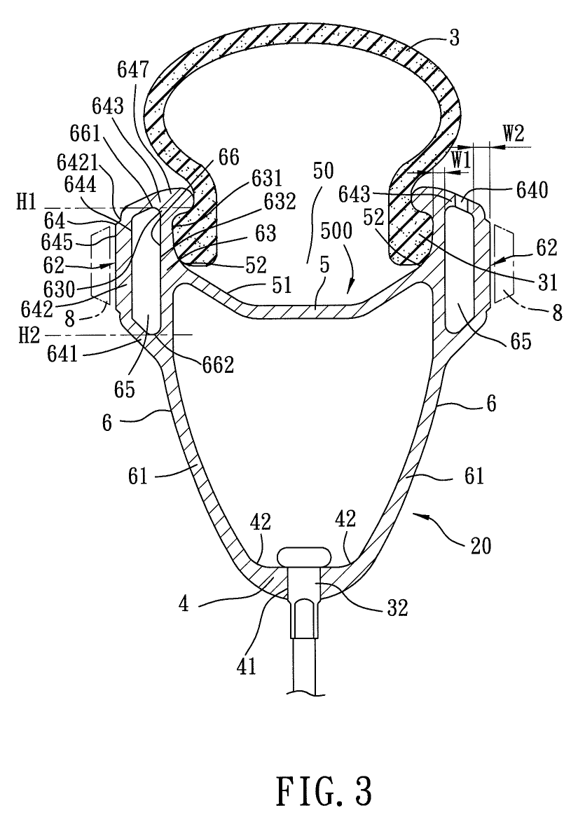

Preferably, the total thickness of the inner wall portion 63 of each of the annular side walls 6 and the connected one of the outer wall portions 64, i.e., the sum of the distance (W1) (See FIG. 3) between the first surface 631 of the inner wall portion 63 and the corresponding second surface 632, and the distance (W2) (See FIG. 3) between the third surface 644 of the outer wall portion 64 and the corresponding brake pad contacting surface 645, is almost equal to the thickness of one of the annular side walls 23 of the conventional wheel rim 2 illustrated in FIG. 1. Therefore, compared to the prior art illustrated in FIG. 1, this embodiment of the present invention has the same weight and further has a higher strength.

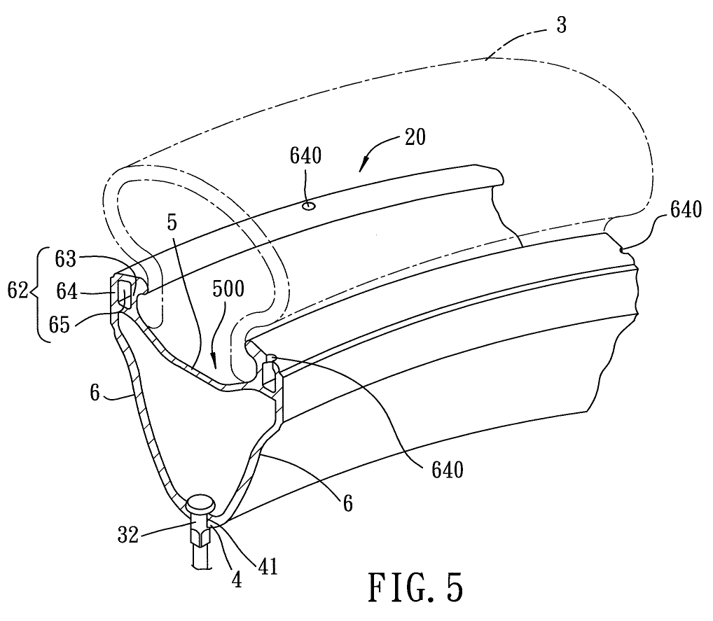

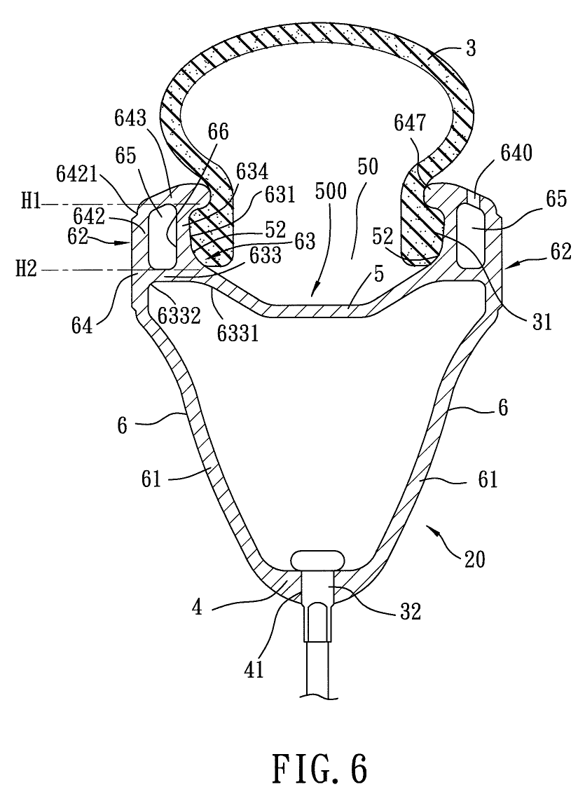

As shown in FIGS. 5 and 6, the second preferred embodiment of the wheel rim according to the present invention has a structure similar to that of the first embodiment. The main difference between this embodiment and the previous preferred embodiment resides in the configuration of the annular side walls 6. In this embodiment, the inner wall portion 63 of the hollow segment 62 of each of the annular side walls 6 includes a linking part 633 that extends in a direction parallel to the rim axis (not shown) and that has a first edge 6331 connected to the annular connecting wall 5 and a second edge 6332 opposite to the first edge 6331, and a radial part 634 that extends radially and outwardly from the first edge 6331 of the linking part 633 relative to the rim axis. The outer wall portion 64 of the hollow segment 62 of each of the annular side walls 6 includes a radially extending part 642 that extends radially and outwardly from the second edge 6332 of the linking part 633 relative to the rim axis and that has a radial outer edge 6421 distal from the annular base wall 4, and a connecting end part 643 extending from the radial outer edge 6421 of the radially extending part 642 to connect to the radial part 634 of the inner wall portion 63. In this embodiment, each of the vent holes 640 formed in the connecting end part 643 of the outer wall portion 64 of each of the annular side walls 6 is a round hole. The second preferred embodiment has the same advantages as those of the first preferred embodiment.

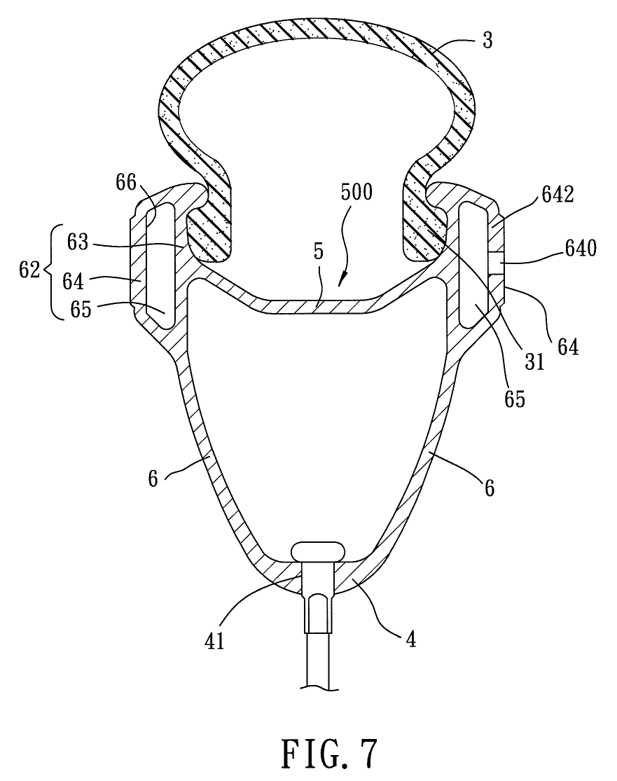

As shown in FIG. 7, the third preferred embodiment of the wheel rim according to the present invention has a structure similar to that of the first embodiment. The main difference between this embodiment and the first preferred embodiment resides in the location of the vent holes 640. In this embodiment, the vent holes 640 are formed in the radially extending part 642 of the outer wall portion 64 of each of the annular side walls 6 and are in spatial communication with the corresponding annular hole 65.

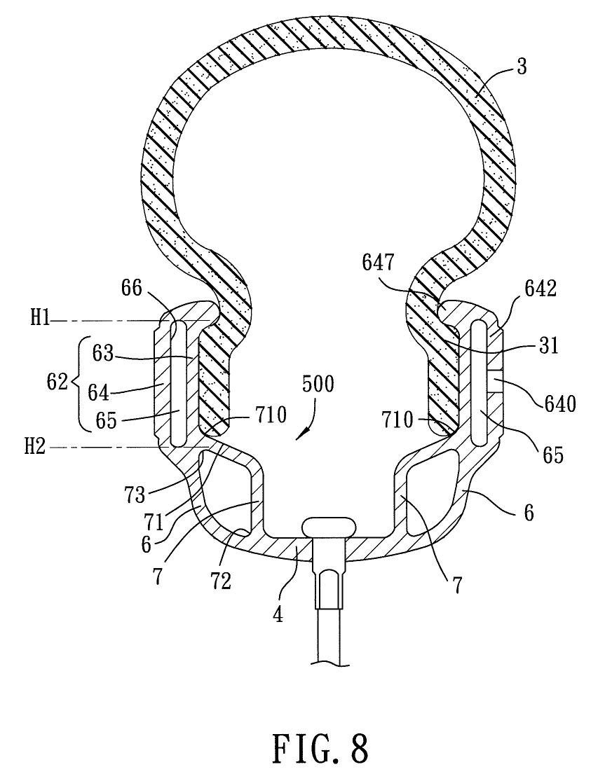

As shown in FIG. 8, the fourth preferred embodiment of the wheel rim according to the present invention has a structure similar to that of the first preferred embodiment. The main difference between this embodiment and the first preferred embodiment resides in the configuration of the stop unit 500. In this embodiment, the stop unit 500 includes a pair of hole-defining walls 7, each of which has a first end 72 that is connected to the annular base wall 4, a second end 73 that is opposite to the first end 72 and that is connected to an adjacent one of the annular side walls 6, and an outer wall surface 71 that faces the other one of the annular side walls 6 and that has a connecting edge 710 connected to the adjacent one of the annular side walls 6 between the first and second imaginary cylindrical planes (H1), (H2). The vent holes 640 are formed in the radially extending part 642 of the outer wall portion 64 of each of the annular side walls 6 and are in spatial communication with the corresponding annular hole 65. The fourth preferred embodiment has the same advantages as those of the first preferred embodiment.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A wheel rim adapted for retaining a tire thereon, the tire having a pair of annular tire beads, said wheel rim comprising an annular rim body having a horizontally disposed rim axis, said rim body including
an annular base wall that has two opposite lateral edges,
a pair of opposite annular side walls that extend radially, outwardly and respectively from said lateral edges of said annular base wall, each of said annular side walls including a hollow segment that is radially spaced apart from said annular base wall and that defines an annular hole, and a connecting segment that interconnects said hollow segment and said annular base wall, said hollow segment having
an inner wall portion that is disposed at a radially inner side of said annular hole, that faces the other one of said annular side walls, and that has a distal edge distal from said annular base wall,
an outer wall portion that is disposed at a radially outer side of said annular hole opposite to said radially inner side of said annular hole, and that includes a radially extending part having a radial outer edge distal from said annular base wall, and a connecting end part extending from said radial outer edge of said radially extending part to connect to said inner wall portion, and
a tire bead retaining part projecting from said distal edge of said inner wall portion toward the other one of said annular side walls, and
a stop unit that cooperates with said inner wall portions of said hollow segments and said tire bead retaining parts of said hollow segments to define an annular tire retaining groove, said inner wall portion of said hollow segment of each of said annular side walls including opposite first and second surfaces that face respectively said annular tire retaining groove and said annular hole, said first surface being adapted for contacting a respective one of the tire beads of the tire and cooperating with said stop unit and said tire bead retaining part of said hollow segment to retain the respective one of the tire beads of the tire in said tire retaining groove.

2. The wheel rim as claimed in claim 1, wherein said stop unit of said rim body includes an annular connecting wall that surrounds said annular base wall, and that interconnects said inner wall portions of said hollow segments of said annular side walls.

3. The wheel rim as claimed in claim 2, wherein:
each of said annular side walls further includes an interior wall surface that faces said annular hole in said hollow segment thereof, and that has a radial outer end distal from said annular base wall and a radial inner end opposite to said radial outer end, said radial outer ends of said interior wall surfaces of said annular side walls being disposed on a first imaginary cylindrical plane, said radial inner ends of said interior wall surfaces of said annular side walls being disposed on a second imaginary cylindrical plane; and
said annular connecting wall has a radial outer surface that faces said annular tire retaining groove, and that has a pair of connecting edges connected respectively to said annular side walls between the first and second imaginary cylindrical planes.

4. The wheel rim as claimed in claim 1, wherein said hollow segment of each of said annular side walls has an interior wall surface defining said annular hole and having an elongated radial cross-section relative to the rim axis.

5. The wheel rim as claimed in claim 1, wherein said outer wall portion of said hollow segment is formed with a plurality of vent holes spaced apart from each other and in spatial communication with said annular hole.

6. The wheel rim as claimed in claim 5, wherein said vent holes are formed in one of said connecting end part and said radially extending part.

7. The wheel rim as claimed in claim 6, wherein said radially extending part further has a brake pad contacting surface disposed outside said annular hole.

8. The wheel rim as claimed in claim 5, wherein each of said vent holes is an elongated hole.

9. A wheel rim adapted for retaining a tire thereon, the tire having a pair of annular tire beads, said wheel rim comprising an annular rim body having a horizontally disposed rim axis, said rim body including:
an annular base wall that has two opposite lateral edges; and
a pair of opposite annular side walls that extend radially, outwardly and respectively from said lateral edges of said annular base wall, each of said annular side walls including a hollow segment that is radially spaced apart from said annular base wall and that defines an annular hole, and a connecting segment that interconnects said hollow segment and said annular base wall, said hollow segment having
an inner wall portion that is disposed at a radially inner side of said annular hole, that faces the other one of said annular side walls, and that has a distal edge distal from said annular base wall,
an outer wall portion that is disposed at a radially outer side of said annular hole opposite to said radially inner side of said annular hole, and that includes a radially extending part having a radial outer edge distal from said annular base wall, and a connecting end part extending from said radial outer edge of said radially extending part to connect to said inner wall portion, and
a tire bead retaining part projecting from said distal edge of said inner wall portion toward the other one of said annular side walls;
wherein one of said radially extending part and said connecting end part of said outer wall portion of said hollow segment is formed with a plurality of vent holes spaced apart from each other and in spatial communication with said annular hole.

10. The wheel rim as claimed in claim 9, wherein each of said vent holes is an elongated hole.

11. The wheel rim as claimed in claim 9, wherein said rim body further includes a stop unit that cooperates with said inner wall portions of said hollow segments of said annular side walls and said tire bead retaining parts of said hollow segments of said annular side walls to define an annular tire retaining groove.

12. The wheel rim as claimed in claim 11, wherein said stop unit of said rim body includes an annular connecting wall that surrounds said annular base wall, and that interconnects said inner wall portions of said hollow segments of said annular side walls.
